(19) United States
(12) Patent Application Publication
(10) Pub. No.: US 2012/0036485 A1
(43) Pub. Date: Feb. 9, 2012

(54) Motion Driven User Interface

(75) Inventors: Oliver Watkins, JR., Toronto (CA); Yousuf Chowdhary, Maple (CA); Jeffrey Brunet, Richmond Hill (CA); Ravinder Sharma, Richmond Hill (CA)

(73) Assignee: XMG Studio, Toronto (CA)

(21) Appl. No.: 13/102,815

(22) Filed: May 6, 2011

Related U.S. Application Data
(60) Provisional application No. 61/401,149, filed on Aug. 9, 2010.

(51) Int. Cl. G06F 3/033

(52) U.S. Cl. 715/863

(57) ABSTRACT

A motion driven user interface for a mobile device is described which provides a user with the ability to cause execution of user interface input commands by physically moving the mobile device in space. The mobile device uses embedded sensors to identify its motion which causes execution of a corresponding user interface input command. Further, the command to be executed can vary depending upon the operating context of the mobile device.

### CROSS-REFERENCE TO RELATED APPLICATIONS

This application claims the benefit of U.S. Provisional Patent Application No. 61/401,149 filed on Aug. 9, 2010 and entitled “Motion Driven User Interface,” which is incorporated herein by reference in its entirety.

### BACKGROUND OF THE INVENTION

1. Field of the Invention

The present invention relates generally to user interfaces for humans to interact with electronic devices particularly those electronic devices that are mobile.

2. Description of the Prior Art

A user interface facilitates the interaction between an electronic device such as a computer and a user by enhancing the user's ability to utilize application programs running on the device. The traditional interface between a human user and a typical personal computer is implemented with graphical displays and is generally referred to as a graphical user interface (GUI). Input to the computer or particular application program is accomplished by a user interacting with graphical information presented on the computer screen using a keyboard and/or mouse, trackball or other similar input device. Such graphical information can be in the form of displayed icons or can simply be displayed text in the form of menus, dialog boxes, folder contents and hierarchies, etc.

Some systems also utilize touch screen implementations of a graphical user interface whereby the user touches a designated area of a screen to affect the desired input. Some touch screen user interfaces, for example the one implemented in the iPhone mobile device made by Apple Inc. of Cupertino, Calif., use what is known as “finger-gestures.” Below is an exemplary list of such finger gestures and the associated commands they cause to be executed:
Double-Tap: A quick double-tap of a user's finger on the device screen: in the Safari web browser distributed by Apple Inc., performing a double-tab on a username/password field on a displayed web-page will zoom-in on that portion of the page and also display the device's on-screen keyboard to assist a user in filling in the form fields. Similarly, a double-tap on the display screen when a video is displayed will zoom-in or enlarge the displayed video while a second double-tap will restore or zoom-out the displayed video to its originally displayed view size.
Drag: While reading an email or viewing the contents of a web-page, a user can slowly drag a finger across the display screen either horizontally or vertically to scroll displayed text on-screen in the chosen direction.
Flick: A flick is similar to a drag except a user moves their finger across the display screen faster than with a drag gesture and then the user lifts their finger off the displayed screen at the end of the drag motion. This causes a faster scroll of the displayed view in the chosen direction than with a drag gesture and one which may continue for a short period of time after the user has lifted their finger from the display screen.
Pinch: A user can employ a two-finger pinch action across the display screen to zoom out of a particular area of the screen. To perform a pinch, a user places two fingers on the display screen and squeezes the fingers together to zoom out and spreads them apart to zoom in.
Delete: Using a flick gesture on the display screen in a horizontal direction over a displayed item such as a video, song or email provides a way for a user to delete the item. Performing a flick gesture causes the device to display a red “delete” button on the display screen which the user can then tap to signal to the device to delete the item. Typically such delete operations then generate a dialog box requesting a user confirm the requested delete operation by tapping a confirmation button before the device actually performs the delete operation. In this way, if a user has a change of mind, they can simply tap a cancel button or tap anywhere other than on the red delete button to cancel the action.

Referring now to FIG. 1, a prior art mobile device touch screen user interface will now be described. Shown as an exemplary mobile device 101 is the iPhone from Apple Inc. positioned or held sideways by a user in a landscape mode (rather than in an upright or portrait mode). Mobile device 101 has a screen display 103 which in this example has a slideshow series of images 103, 104, 105, 106, 107 and 108 displayed thereon. Mobile device 101 also has a traditional touch screen graphical user interface element known as a slider bar 107 displayed on display 103. Slider bar 107 includes a displayed sliding element 109 which a user can touch and using the drag command can move sliding element 109 back and forth along slider bar 107. In this example, a user doing so causes the slideshow series of images 103, 104, 105, 106, 107 and 108 to cycle back and forth by, for example, changing from displaying image 105 to displaying image 104 as the user drags sliding element 109 of slider bar 107 to the left and then changing back to displaying image 105 when the user drags sliding element 109 of slider bar 107 back to the right and then changing from displaying image 105 to displaying image 106 as the user continues to drag sliding element 109 of slider bar 107 to the right.

In a similar fashion, mobile device 101 may also have a traditional touch screen graphical user interface where, rather than using slider bar 107 with sliding element 109 to effect moving between images 103, 104, 105, 106, 107 and 108, instead the user simply touches the displayed images themselves and again using the drag command cycles through them.

There are, however, many applications where the user interfaces discussed above are impractical or inefficient. Having to use a separate input device such as a mouse to interact with a GUI becomes inconvenient when that means carrying both a mobile device and a mouse device and further requires the use of two hands, one to hold the mobile device and one to operate the mouse device. This later limitation likewise exists in the case of traditional touch screen user interfaces deployed on mobile devices. These limitations of the prior art are overcome by providing a motion driven user interface for mobile devices as described herein.

### SUMMARY

In one example is a mobile device user interface method comprising: detecting motion of the mobile device using one or more sensors located within the mobile device; confirming by a processor of the mobile device that the detected motion of the mobile device exceeds a preset threshold; determining by the mobile device processor that the confirmed detected motion of the mobile device matches a defined type of motion; and executing by the mobile device processor a user interface input command associated with the defined type of motion.

In a further example of the mobile device user interface method, the user interface input command associated with the defined type of motion varies depending upon what context in which the mobile device user interface is operating when the step of detecting motion of the mobile device occurs.

In another example is a non-transitory computer readable medium containing programming code executable by a processor, the programming code configured to perform mobile device user interface method, the method comprising: detecting motion of the mobile device using one or more sensors located within the mobile device; confirming by a processor of the mobile device that the detected motion of the mobile device exceeds a preset threshold; determining by the mobile device processor that the confirmed detected motion of the mobile device matches a defined type of motion; and executing by the mobile device processor a user interface input command associated with the defined type of motion.

### BRIEF DESCRIPTION OF DRAWINGS

FIG. 1 depicts a prior art mobile device touch screen user interface.

FIG. 2 an exemplary process flowchart of one embodiment.

FIG. 3 is a diagram of various possible physical motions of a mobile device according to one embodiment.

FIG. 4 is an example of linear motion of a mobile device along an x-axis causing execution of a user interface input command according to one embodiment.

FIG. 5 is an example of linear motion of a mobile device along a y-axis causing execution of a user interface input command according to one embodiment.

FIG. 6 is an example of linear motion of a mobile device along a z-axis causing execution of a user interface input command according to one embodiment.

FIG. 7 is an example of angular motion of a mobile device about the y-axis causing execution of a user interface input command in a first operating context according to one embodiment.

FIG. 8 is another example of angular motion of at device about the y-axis causing execution of a user interface input command in a second operating context according to one embodiment.

FIG. 9 is an example of a composite motion of a mobile device about the z-axis causing execution of a user interface input command according to one embodiment.

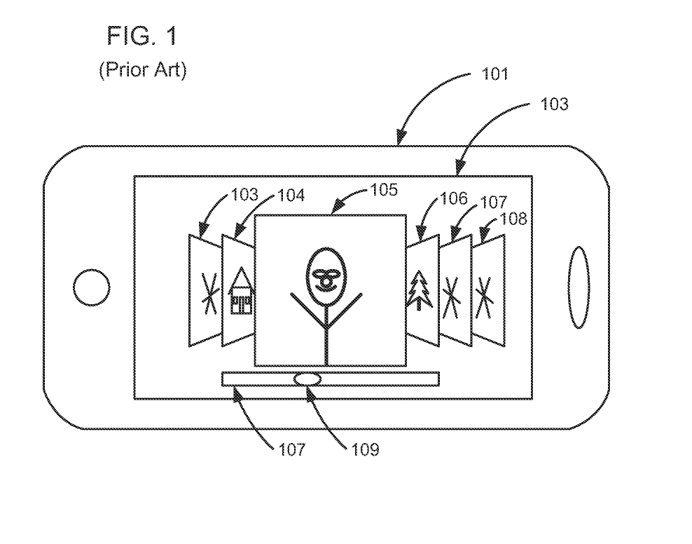

### DETAILED DESCRIPTION OF THE INVENTION

In various embodiments are provided methods and systems for a motion driven context sensitive user interface for mobile devices. In one embodiment the method provides a user with the option to cause execution of certain user interface input commands by physically moving the mobile device in space. This provides a user with the convenience of interacting with the mobile device using embedded sensors in the mobile device. By gathering and processing data from multiple sensors within the mobile device, certain commands can be executed that in the past required a traditional user interface such as a graphical user interface.

As portable electronic devices become more compact, and the number of functions performed by a given device increase, it has become a significant advantage to use these portable devices for functions other than the ones they were originally designed for. Some mobile devices like the iPhone whose main function may be considered to be primarily a phone can also be used for gaming as they provide enough computing power, incorporate a touch screen interface and have embedded sensors like global positioning system (GPS), camera, compass, gyroscope and accelerometer. Such devices are ripe for a shift in the way user interfaces are implemented. Taking advantage of these embedded sensors, a motion driven user interface is disclosed herein. Thus by moving the device in space certain commands can be executed as will be described.

As has been discussed, menu driven GUIs are tedious and often require the use of both hands (e.g., one hand to hold the device and the other to control an external input device or touch the screen). However, using the approach described herein, certain motions are natural and can be easily performed with one hand which is holding the mobile device, thus giving the user the freedom to do other tasks with the spare hand, while still meaningfully interacting with the mobile device.

The present disclosure describes a motion driven user interface as a method and a system that uses the output of multiple sensors available in a mobile device to capture the motion and then performing a command/task associated with that particular motion.

Various sensors available on mobile devices are briefly discussed below:
Digital Compass. An electro-magnetic device that detects the magnitude and direction of the earth's magnetic field and point to the earth's magnetic north. Used to determine initial state, and then to determine ground-plane orientation during use/play.
Accelerometer. Used for corroborating the compass when possible, and for determining the up-down plane orientation during use/play. In an augmented reality (AR) game compass and accelerometer provide directionality information.
Gyroscope. A gyroscope is a device for measuring or maintaining orientation, based on the principles of conservation of angular momentum. Gyroscopes can be mechanical or based on other operating principles, such as the electronic, microchip-packaged micro-electro-mechanical systems (MEMS) gyroscope devices found in consumer electronic devices. Gyroscopes are used for navigation when magnetic compasses do not work, or for stabilization, or to maintain direction.

This application discloses methods and systems that use one or more of the above listed embedded sensors in a mobile device to implement a motion driven user interface to further enhance the user experience.

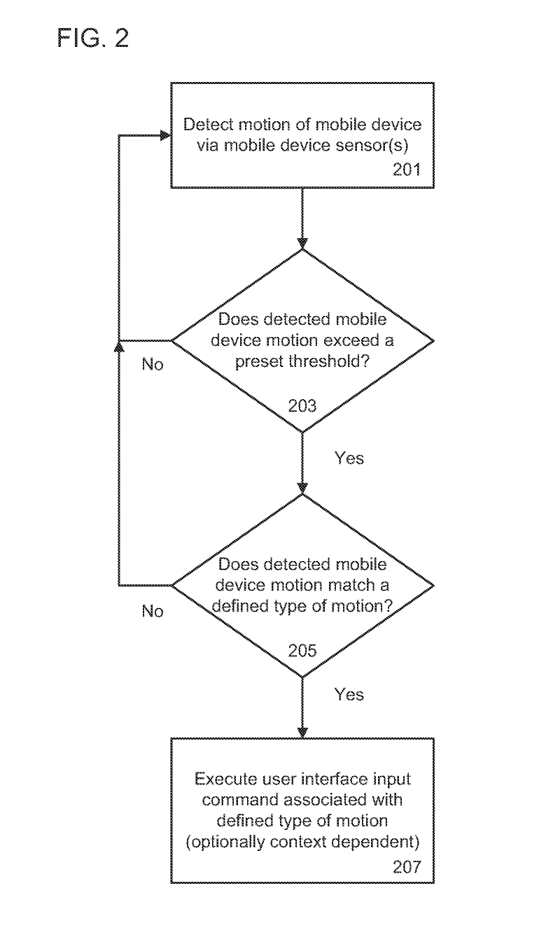

Referring now to FIG. 2, an exemplary process flowchart of one embodiment can be seen. In step 201, a user's physical movement or motion of the mobile device is detected by the mobile device using one or more sensors located within the mobile device. In step 203, it is determined whether the detected motion exceeds a preset threshold which differentiates between intended motions caused by the user from those that may be un-intended and instead caused by the normal movement of the user for example while walking. If the detected motion does not exceed the preset threshold in step 203 then the process returns to step 201. Alternatively, if the detected motion does exceed the preset threshold in step 203 then, in step 205, it is determined whether the detected mobile device motion matches a defined type of motion. If the detected motion does not match a defined type of motion in step 205 then the process returns to step 201. Alternatively, if the detected motion does match a defined type of motion in step 205 then a user interface input command associated with the defined type of motion is executed by the mobile device in step 207.

In various embodiments the operations and processing described are handled by a processor of the mobile device running software stored on the mobile device stored in memory of the mobile device.

While any such defined type of motion may be used, in one embodiment these motions are typically either a linear motion, an angular motion or a composite motion (it is to be understood that a composite motion is a combination of more than one linear motion, a combination of more than one angular motion or a combination of at least one linear motion and at least one angular motion) as will be explained.

In this way the mobile device, using its sensors, can measure and calculate a range of motions that can then be translated to commands that are context-specific, i.e., the command is different depending upon the operating context of the mobile device. As such, in some embodiments, the user interface input command associated with the defined type of motion is dependent upon what context the mobile device is operating in at the time motion of the mobile device is detected in step 201 as will be explained.

To be clear, an operating context is the current user interface operational mode or state of the mobile device which in various examples is when the mobile device is displaying to the user one application's GUI versus displaying to the user a different application's GUI, or when the mobile device is displaying to the user an application's GUI when running one part or function of the application versus displaying to the user that application's GUI when running a different part or function of the same application, or when the mobile device is displaying to the user an application GUI versus displaying to the user an operating system function GUI. It is to be understood that operating context can vary by part or function of an application, by part or function of one application versus part or function of a different application, or by part or function of an operating system and can also vary depending upon particular hardware components of the mobile device (e.g., what sensors are included in the mobile device, what other user interface input devices are included in or coupled to the mobile device, etc.).

In various embodiments, the association between a defined type of motion and its user interface input command is mapped in a table, or may use a database or a file for such mapping. The mapping may vary from one context to another. For example when playing an AR game, game related motions may be applicable. Alternatively, the mapping may change as the user progresses from one level of the game to another. Exemplary defined types of motions and associated user interface input commands are shown in the table below which also shows examples of different commands which may be executed dependent upon the operating context of the mobile device when the device motion occurs.

| Motion | Command |
|---|---|
| Linear motion along x-axis (move right) | pan right, play slideshow/video, roll forward in |
| | a radial view |
| Linear motion along x-axis (move left) | pan left, pause slideshow/video, roll back in a |
| | radial view |
| Linear motion along y-axis (move up) | pan up, maximize view, move to higher level in |
| | folder hierarchy |
| Linear motion along y-axis (move down) | pan down, minimize view, move to lower level |
| | in folder hierarchy |
| Linear motion along z-axis (move in/forwards) | zoom in |
| Linear motion along z-axis (move | zoom out |
| out/backwards) | |
| Quick linear motion along x-axis (double move | repeat previous action, fast forward |
| right aka fast jab right) | slideshow/video |
| Quick linear motion along x-axis (double move | undo previous action, rewind slideshow/video |
| left aka fast jab left) | |
| Repeated linear motion along x-axis (repeated | scramble, reorganize, horizontal sort, |
| back and forth motion aka sideways shake) | disapprove |
| Quick linear motion along y-axis (double move | jump, scroll up or page up, move to top of |
| up aka fast jab up) | folder hierarchy |
| Quick linear motion along y-axis (double move | duck, scroll down or page down, move to |
| down aka fast jab down) | bottom of folder hierarchy |
| Repeated linear motion along y-axis (repeated | charge weapon, flip, vertical sort |
| up and down motion) | |
| Quick linear motion along z-axis (double move | push, knock down, knock out, approve |
| in aka fast jab forwards) | |
| Quick linear motion along z-axis (double move | grab & pull, tug, or yank |
| out aka fast jab backwards) | |
| Repeated linear motion along z-axis (repeated | wake up device, end process, jolt game |
| in and out motion) | opponent |
| Angular motion about an x-axis (roll/tilt | Accelerate forward |
| back/pitch back) | |
| Angular motion about an x-axis (roll/tilt | Decelerate/brake |
| forward/pitch forward) | |
| Quick angular motion about an x-axis (quick | Continue/go/Enter key |
| roll/tilt back/pitch back) | |
| Quick angular motion about an x-axis (quick | Return/Backspace key/Escape key |
| roll/tilt forward/pitch forward) | |
| Repeated angular motion about an x-axis | Winding/reeling |
| (repeated roll/tilt back/pitch back) | |
| Repeated angular motion about an x-axis | Unwinding/unreeling |
| (repeated roll/tilt forward/pitch forward) | |
| Angular motion about a y-axis (pivot/turn | Cycle forward through photo |
| clockwise/yaw clockwise) | album/slideshow, open/close door in a game |
| Angular motion about a y-axis (pivot/turn | Cycle backward through photo |
| counterclockwise/yaw counterclockwise) | album/slideshow, open/close door in a game |
| Angular motion about a z-axis (rotate/tilt | Make a right turn |
| right/roll clockwise) | |
| Angular motion about a z-axis (rotate/tilt | Make a left turn |
| left/roll counterclockwise | |
| Repeated angular motion about a y-axis | vacuum effect |
| (double yaw clockwise) | |
| Repeated angular motion about a y-axis | Blowing fan effect |
| (double yaw counterclockwise) | |
| Quick angular motion about a z-axis (quick roll | Send to front |
| clockwise) | |
| Quick angular motion about a z-axis (quick roll | Send to back |
| counterclockwise) | |
| Repeated angular motion about a z-axis | Polish/shine/buff surface |
| (double roll clockwise) | |
| Repeated angular motion about a z-axis | Erase |
| (double roll counterclockwise) | |
| Repeated back and forth angular motion or | Stabilize drifting car |
| forth and back angular motion about a z-axis | |
| (counterclockwise and clockwise or clockwise | |
| and counterclockwise) | |
| Composite linear motion along y-axis and x- | Frame or crop an image |
| axis (up, right, down and left) | |
| Composite linear motion along z-axis (move | Tunneling in/boring in/screwing in/causing |
| in/forwards) and angular motion about a z-axis | clockwise turbulence |
| (rotate/tilt right/roll clockwise) | |
| Composite linear motion along z-axis (move | Tunneling out/boring out/unscrewing/causing |
| out/backwards) and angular motion about a z- | counterclockwise turbulence |
| axis (rotate/tilt left/roll counterclockwise) | |

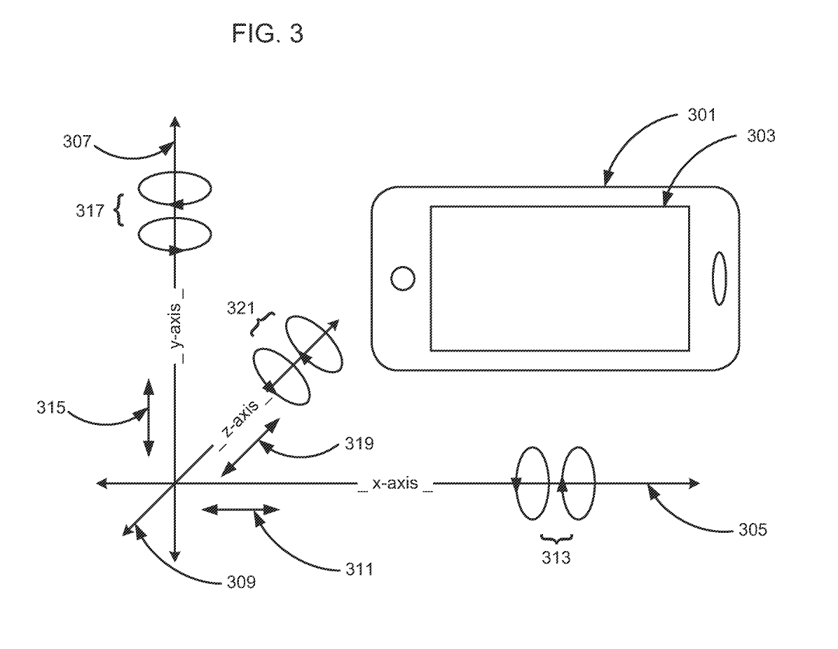

Referring now to FIG. 3, again according to one embodiment, various defined motions will now be explained. A mobile device 301, which again may be an iPhone mobile device from Apple, Inc., is shown positioned in a landscape mode and having a display screen 303. The positioning of mobile device 301 is also shown corresponding to three orthogonal axes shown and labeled as an “x-axis” 305 paralleling the bottom or long dimension of mobile device 301 in a landscape position, a “y-axis” 307 paralleling the edge/side or short dimension of mobile device 301 in a landscape position, and a “z-axis” 309 perpendicular to screen 303 or the front face of mobile device 301. As will now be explained, a user can move mobile device 301 relative to these axes in various fashions.

Mobile device 301 can be moved laterally (left to right or right to left in the figure) along x-axis 305 as indicated by movement arrow 311 in the figure. Mobile device 301 can likewise be moved longitudinally (up or down in the figure) along y-axis 307 as indicated by movement arrow 315 in the figure. Mobile device 301 can also be moved in or out of the figure along z-axis 309 as indicated by the movement arrow 319 in the figure. These are the linear motions of mobile device 301.

Mobile device 301 can be moved in a clockwise or counterclockwise fashion (rotated) about x-axis 305 as indicated by a pair of rotation arrows 313 in the figure. Mobile device 301 can likewise be moved in a clockwise or counterclockwise fashion (rotated) about y-axis 307 as indicated by a pair of rotation arrows 317 in the figure. Mobile device 301 can also be moved in a clockwise or counterclockwise fashion (rotated) about z-axis 309 as indicated by a pair of rotation arrows 319 in the figure. These are the angular motions of mobile device 301.

Mobile device 301 can also be moved via a combination of the linear motions, the angular motions or both, as previously stated. These are the composite motions of mobile device 301.

It is to be understood that although the intersection of the three axes, namely x-axis 305, y-axis 307 and z-axis 309, commonly referred to as an origin, is shown as being located some distance from mobile device 301 in the figure, this was merely done for visually clarity in the figure and therefore need not be the case in any given situation. Thus, the origin may be located at any point in space relative to mobile device 301 including touching or even within mobile device 301. Therefore, any discussion herein regarding mobile device movement with respect to the three axes (whether linear, angular or composite) is likewise understood to cover any placement of the origin and the three axes relative to mobile device 301. For example, discussion herein of angular motion of mobile device 301 about y-axis 307 can mean that mobile device 301 starts from a position some distance along x-axis 305 and therefore all of mobile device 301 is moving around y-axis 307 (in which case all of mobile device 301 is moving through space) or can mean that a left edge of mobile device 301 starts from a position no distance along x-axis 305 (in which case the left edge of mobile device 301 is coincident with y-axis 307) and therefore the rest of mobile device 301 is moving around y-axis 307 while the left edge of mobile device 301 stays stationary (in which case mobile device 301 is pivoting about its left edge), or can mean that some part of mobile device 301 starts from a position some negative distance along x-axis 305 and therefore the rest of mobile device 301 on either side of that part of mobile device 301 is moving around y-axis 307 while that part of mobile device 301 stays stationary (in which case mobile device 301 is essentially stationary while rotating in space).

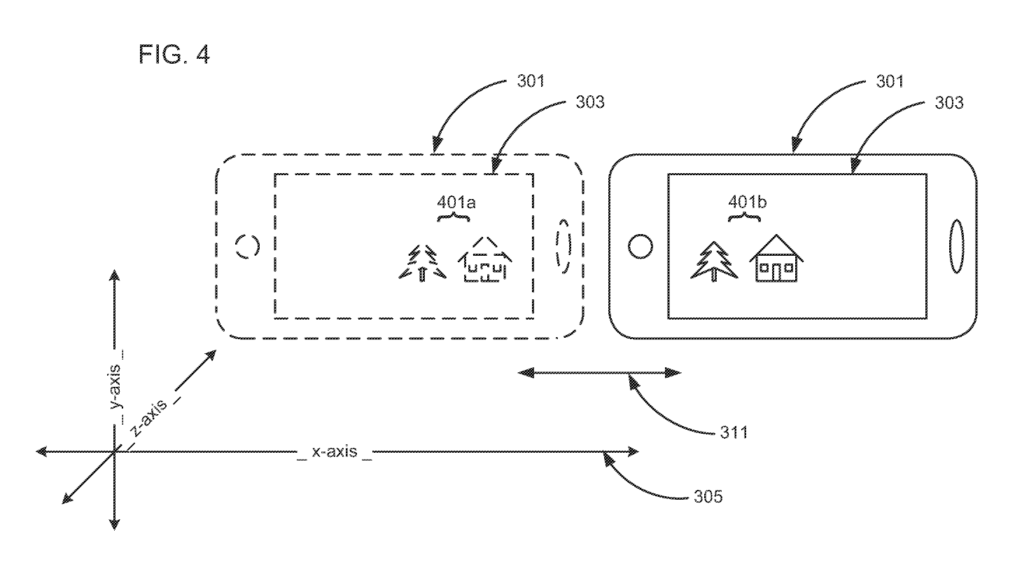

Referring now to FIG. 4, examples of linear motion along x-axis 305 will now be described. Mobile device 301 is shown being moved sideways by a user laterally from left to right (and can also be moved laterally in the opposite direction, that is, from right to left) along x-axis 305 as indicated by movement arrow 311 in the figure. Mobile device 301 is shown having a display screen 303 on which is displayed a scene 401a of a tree and a house before being moved sideways by a user laterally from left to right along x-axis 305 which then appears as scene 401b of the same tree and house after being moved. In the operating context of mobile device 301 when this lateral movement along x-axis 305 occurred, as can be seen in the figure, an associated user interface input command is executed to move the tree and house of scene 401a laterally across display screen 303 of mobile device 301 to become scene 401b due to the user having moved mobile device 301 from left to right along x-axis 305.

This is accomplished because a user's movement of mobile device 301 is detected by sensors within the mobile device such as a gyroscope and an accelerometer which sensors inform the mobile device when the user starts and stops the motion. When the mobile device detects that a motion has started, it can then continue to track changes in the X, Y, or Z coordinates of the mobile device's position for changes until it detects that the motion has stopped. If the mobile device calculates a net change with respect to an initial stationery position in coordinates along x-axis 305, e.g., from a smaller value to a larger value, and it does not measure any appreciable changes in coordinates along either of y-axis 307 or z-axis 309 (for example, a preset threshold of a change in magnitude less than 10% of either y-axis 307 or z-axis 309 of the magnitude of the delta vector in x-axis 305), then the mobile device can conclude that the user performed an intentional left-to-right lateral motion with the device. Of course, the preset threshold can be definable and may vary from one instance to the other depending on implementation and operating context.

Of course, if the operating context were different, for example if a video was paused on display screen 303 of mobile device 301 when the lateral movement occurred, some other associated user interface input command would execute, for example, to play the video. Likewise, if mobile device 301 is then moved back laterally to the left then an associated user interface input command of pausing the video would be executed.

In a further embodiment, the speed with which the mobile device is moved, again as sensed via sensors within the mobile device, can also be used to determine a defined type of motion. For example, a quick lateral movement to the right can be a defined type of motion such that if the mobile device is so moved when playing a video on the display screen this can cause a fast-forward user interface input command to be executed. Likewise a quick lateral movement to the left can be a defined type of motion such that if the mobile device is so moved when playing a video on the display screen this can cause a rewind user interface input command to be executed.

Numerous other examples are possible including moving a mobile device laterally towards the left with respect to an initial stationery position to cause execution of a user interface input command of panning left in a virtual world or rolling back a radial view, whereas a quick sideways or lateral ‘jab’ to the left can cause execution of a user interface input command to undo a previous action or rewind a video as has been explained. Likewise, moving the device towards the right with respect to an initial stationery position can cause execution of a user interface input command to pan right in a virtual world, roll forward in a radial view, or play a video—whereas a quick sideways or lateral ‘jab’ to the right might execute a user interface input command to fast forward the video or repeat or redo a previous action. Similarly, a ‘sideways shake’ motion where the user moves the mobile device laterally to the left and laterally to the right repeatedly might execute, depending on the context, a user interface input command to scramble, reorganize, or sort when a list view or other view which contains individually selectable elements is displayed on a display screen of the mobile device.

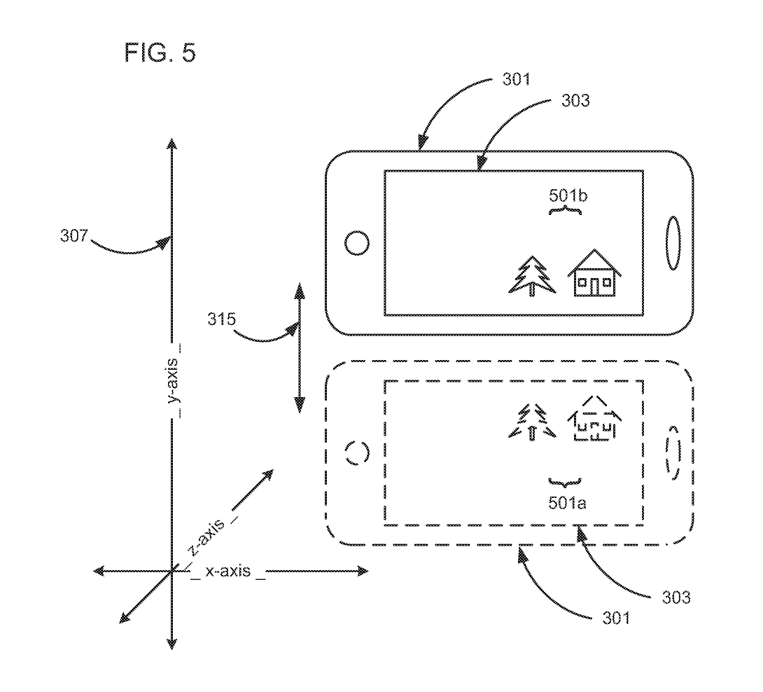

Referring now to FIG. 5, examples of linear motion along y-axis 307 will now be described. Mobile device 301 is shown being moved by a user up and down along y-axis 307 as indicated by movement arrow 315 in the figure. Mobile device 301 is shown having a display screen 303 on which is displayed a scene 501a of a tree and a house before being moved up by a user along y-axis 307 which then appears as scene 501b after being moved. In the operating context of mobile device 301 when this upward movement along y-axis 307 occurred, as can be seen in the figure, an associated user interface input command is executed to move the tree and house of scene 501a downwards across display screen 303 of mobile device 301 to become scene 501b due to the user having moved mobile device 301 upwards along y-axis 307.

Again, this is accomplished because a user's movement of mobile device 301 is detected by sensors within the mobile device which sensors inform the mobile device when the user starts and stops the motion. In order to determine and calculate the up-down motions the mobile device compares the coordinate values along the y-axis with respect to an initial stationary position, while the coordinate values along the x-axis and z-axis remain relatively unchanged, i.e., less than some preset threshold. If the net difference between the initial position and a final position is positive (i.e. difference between coordinate values along the y-axis) then an upwards motion is indicated whereas a net negative change indicates a downwards motion.

Thus in one embodiment when a user moves the mobile device upwards with respect to the initial stationery position can cause execution of a user interface input command of panning the camera up in a virtual world or moving to a higher level in a folder hierarchy, whereas a quick ‘jab’ up motion can cause execution of a user interface input command to make the user's displayed avatar jump in that virtual world or move to the top of a folder hierarchy again depending upon implementation and operating context.

Likewise, the user moving the mobile device downwards with respect to the initial stationery position can cause execution of a user interface input command of panning the camera down in a virtual world or moving to a lower level in a folder hierarchy, whereas a quick ‘jab’ down motion can cause execution of a user interface input command to make the user's displayed avatar duck or slide in that virtual world or move to the bottom of a folder hierarchy.

Another possible example based on detected speed of a motion is a quick ‘up-down shake’ where the user quickly moves the mobile device up and down repeatedly which can cause execution of a user interface input command, depending on implementation and operating context, of charging a weapon in a game, making the user's displayed avatar flip through the air after a jump, or a vertical sort similar to how the horizontal or lateral quick sideways shake corresponds to a horizontal sort.

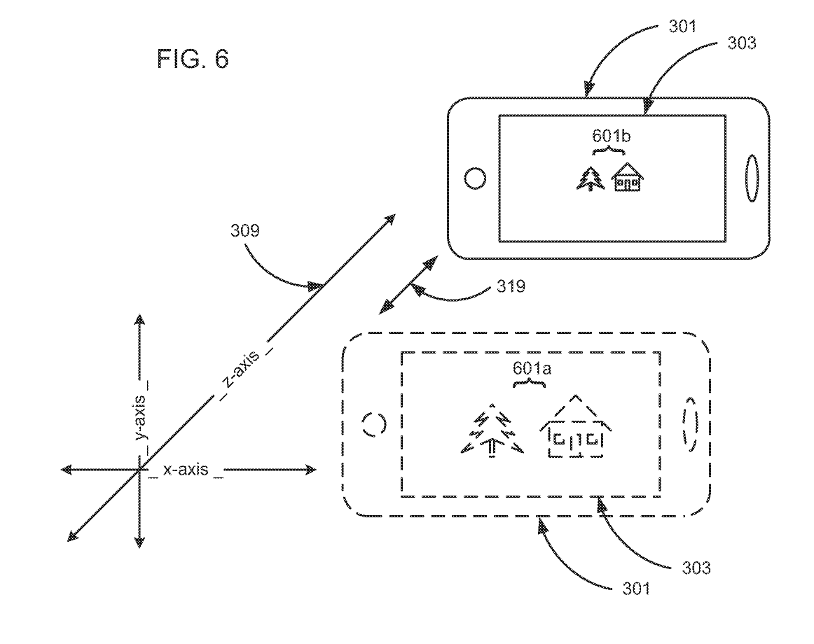

Referring now to FIG. 6, examples of linear motion along z-axis 309 will now be described. Mobile device 301 is shown being moved by a user in (forwards) and out (backwards) along z-axis 309 as indicated by movement arrow 319 in the figure. Mobile device 301 is shown having a display screen on which is displayed a scene 601a of a tree and a house before being moved out or backwards by a user along z-axis 309 which then appears as scene 601b after being moved. In the operating context of mobile device 301 when this backward movement along z-axis 309 occurred, as can be seen in the figure, an associated user interface input command is executed to zoom out the scene thus reducing the displayed size of the tree and house of the scene as shown in scene 601b.

Again, this is accomplished because a user's movement of mobile device 301 is detected by sensors within the mobile device such as a gyroscope and an accelerometer which sensors inform the mobile device when the user starts and stops the motion. In order to determine and calculate the in-out motions the mobile device compares coordinate values along the z-axis with respect to an initial position, while the coordinate values along the x-axis and y-axis remain relatively unchanged, i.e., less than some preset threshold. If the net difference between the initial position and a final position is positive (i.e., the difference between coordinate values along the z-axis) then an outwards or forward motion is indicated whereas a net negative change indicates an inwards or backward motion.

Thus in one embodiment when a user moves the mobile device away from the user with respect to the initial stationery position can cause execution of a user interface input command to zoom-out of a displayed scene. This zoom-out command can likewise occur in the operating context of a displayed AR image received from the output of a video capture device (e.g. a camera) of the mobile device where, by the user moving the mobile device away from themselves the AR image can be zoomed-out as shown in the figure.

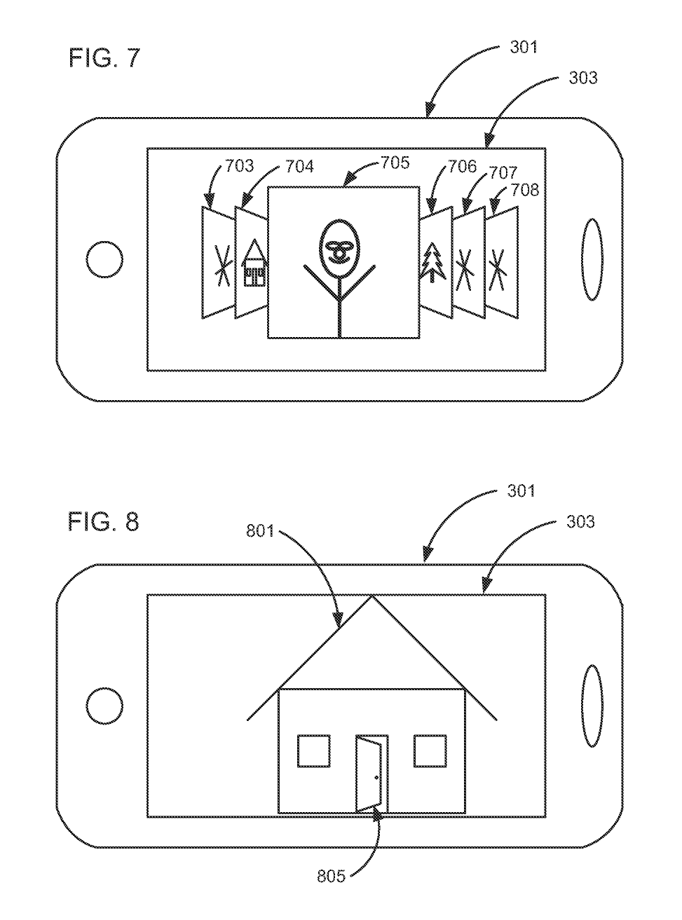

Referring now to FIG. 7, examples of angular lotion about the y-axis will now be described. In these examples, mobile device 301 is moved by a user in an angular or rotational fashion about the y-axis as previously described. Mobile device 301 is shown having a display screen 303 on which is displayed a slideshow sequence of images 703, 704, 705, 706, 707 and 708. In the operating context of mobile device 301 when the user moves mobile device 301 in an angular backwards or counter-clockwise fashion about the y-axis causes execution of a user interface input command in mobile device 301 for the slideshow sequence of images to begin to play such that the slideshow transitions from having image 705 prominently displayed to having image 706 prominently displayed to then having image 707 be prominently displayed, etc. Likewise, when the user moves mobile device 301 in an angular forwards or clockwise fashion about the y-axis causes execution of a user interface input command in mobile device 301 for the slideshow sequence of images to pause such that a current prominently displayed image stays as the prominent displayed image or the slideshow sequence of images moves backwards from, for example, having image 706 prominently displayed to then having image 705 be prominently displayed depending upon implementation and operating context.

Again, this is accomplished because a user's movement of mobile device 301 is detected by sensors within the mobile device which sensors inform the mobile device of the motion or movement of the mobile device. Using these sensors the mobile device can determine, for example, that the right side of the device is rotating clockwise about the y-axis while the left side of the device has remained in a relatively constant position, i.e., less than some preset threshold. In this example, referring now to FIG. 8, this would indicate that the relative y-axis passes through the left side of mobile device 301, and thus the user is moving mobile device 301 as they would open a door to thereby cause a similar action in a graphical user interface of mobile device 301 in the operating context of a game or virtual world as is depicted in the figure where a house 801 with a door 805 is shown displayed on a display screen 303 of mobile device 301. In this example, a user interface input command to further open door 805 of house 801 can be caused to be executed by a user rotating mobile device 301 counterclockwise about its left edge and, conversely, a user interface input command to further close door 805 of house 801 can be caused to be executed by a user rotating mobile device 301 clockwise about its left edge.

Further, as has been explained, a user's movement of mobile device 301 can cause execution of a different user interface input command depending upon which operating context mobile device 301 is operating in when mobile device 301 detects that it has been moved by the user. For example, in the example shown with reference to FIG. 7 the operating context is that of a slideshow of images such that movement of the mobile device could cause execution of a first user interface input command as has been described whereas in the example shown with reference to FIG. 8 the operating context is that of a virtual world or game space such that movement of the mobile device could cause execution of a second user interface input command as has been described.

In one embodiment a preset threshold is defined to eliminate a possible margin of error (for example 10 angular degrees) within which the orientation of the left hand side of the mobile device could vary. Since the change in the right side of the device increased about the positive z-axis (and somewhat toward the negative X-axis) outside of the margin of error and the changes in the left side of the device were within the margin of error, the mobile device can then positively conclude that the user did rotate the right side of the device inward or forward.

Specifically, if the mobile device received linear position coordinates of the mobile device along the x-axis, y-axis and z-axis through the accelerometer, gyroscope, and/or other sensors from the sides of the device, then it would first transform these coordinates to a spherical coordinate system. As an example:

Let:

phi=a tan 2(x,y)

theta=a cos(z/r)

r=sgrt(x̂2+ŷ2+ẑ2)

Then:
phi on the left hand side of the device should be within the margin of error (<10% difference from its original value).
phi on the right hand side of the device should be outside of the margin of error (>10% difference from its original value).
theta and r should be within the margin of error

Again, this is accomplished because a user's movement of mobile device 301 is detected by sensors within the mobile device which sensors measure the acceleration and deceleration of the device, which sensors inform the mobile device when the user starts and stops the motion. When the mobile device detects that a motion has started, it can then continue to track changes in the phi, theta, or r coordinates of the device's polar position for changes until it detects that the motion has stopped. If the mobile device calculates a net change with respect to the initial stationery position in the value of right-side phi coordinates, e.g., from a negative value to a positive value, and it does not measure any appreciable changes in the coordinates of theta and r (for example a change in magnitude less than 10% of the magnitude of the delta vector in the two radii), then the system can conclude that the user performed an intentional rotation around the left edge motion with the device.

Thus in one embodiment when a user moves the right edge of the mobile device while the left edge stays relatively fixed with respect the initial stationery position can cause execution of a user interface input command to cycle forward through a photo album, open or close a door in a displayed game, etc., depending upon implementation and operating context.

Likewise, moving the device from the left edge white the right edge stays relatively fixed, with respect to the initial stationery position can cause execution of a user interface input command to cycle backward through a photo album, open or close a door in a displayed game, etc., depending upon implementation and operating context.

Another possible example based on detected speed of motion is when the user quickly and repeatedly moves the mobile device back and forth along one edge while the other edge stays relatively stationary, which movement can cause execution of a user interface input command to simulate a vacuum or a fan-blowing effect where various adjustable displayed elements are ‘blown’ or ‘sucked’ to the waving side of the screen.

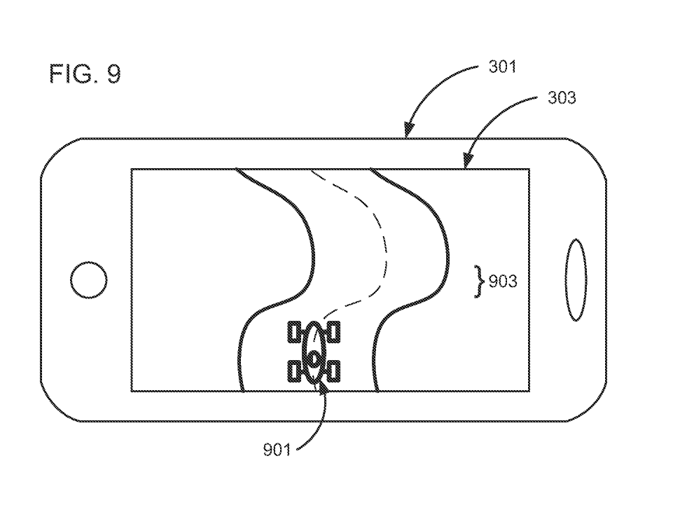

Referring now to FIG. 9, examples of angular motion about the z-axis will now be described. In these examples, mobile device 301 is moved by a user in an angular or rotational fashion about the z-axis as previously described. Mobile device 301 is shown having a display screen 303 on which is displayed a racing video game having an overhead view of a race car 901 on a racetrack 903. In the operating context of mobile device 301 when the user moves mobile device 301 in a rotational clockwise fashion about the z-axis causes execution of a user interface input command in mobile device 301 for the race car 901 to make a right turn and when the user moves mobile device 301 in a rotational counterclockwise fashion about the z-axis causes execution of a user interface input command in mobile device 301 to make a left turn. In this way a user of mobile device 301 playing the racing video game can steer race car 901 along racetrack 903 by simply rotating mobile device 301 clockwise and counterclockwise about the z-axis when mobile device is in the operating context of running the video game.

Thus in one embodiment when the user moves the mobile device in a clockwise direction about the z-axis as the center of rotation with respect to the initial stationery position can cause execution of a user interface input command to make a right turn, as when driving in the video game example. Similarly, a quick clockwise ‘toss’ angular motion about the z-axis can cause execution of a user interface input command to ‘send-to-back’ a top most view, as when shuffling cards, etc. Likewise, a user moving the device in a counterclockwise angular motion about the z-axis as the center of rotation with respect to the initial stationery position can cause execution of a user interface input command to make a left turn, as when driving in the video game example. Similarly, a quick counterclockwise ‘toss’ angular motion about the z-axis can cause execution of a user interface input command to ‘send-to-front’ a bottom most view, as when shuffling cards, etc. Still further, a repeated clockwise and counter-clockwise alternating rotation or angular motion about the z-axis can cause execution of a user interface input command to stabilize a drifting car in a racing game or to unlock a locked file provided the correct sequence of precise ‘twists’ or rotations are applied, as with a combination lock. Again, it is to be understood that each of these defined type of motions and their associated user interface input commands are dependent upon implementation and operating context.

In another example (not shown) of angular motion of a mobile device is a user's rotation or angular motion of the mobile device about the x-axis. By the user tipping top edge of the mobile device away from the user, with either the bottom edge remaining stationary or moving towards the user) in a rotational or angular direction about the x-axis with respect to an initial stationary position of the device can cause execution of a range of user interface input commands depending on implementation and operating context.

Thus in one embodiment a user tipping the top edge of the mobile device backwards (moving the top of the device away from the user with the X-axis as the center of rotation with respect to the initial stationery position) can cause execution of a user interface input command to accelerate forward, such as when pressing the gas pedal of a vehicle (e.g., race car 903 of FIG. 9), whereas a quick ‘flick forward’ rotational or angular motion about the x-axis can cause execution of a user interface input command to ‘continue’ or ‘go’, such as when a user presses a key on a keyboard to move forward or progress to a next view.

Likewise, a user tipping the bottom edge of the mobile device backwards (moving the bottom of the device away from the user with the X-axis as the center of rotation with respect to the initial stationery position) can cause execution of a user interface input command to press the brake pedal of a vehicle (e.g., race car 903 of FIG. 9), whereas a quick “flick backward” rotational or angular motion about the x-axis can cause execution of a user interface input command to ‘return’ or move ‘backward’, such as when a user presses a Backspace or Escape key on the keyboard to return, stop or backup to a previous view.

Further, in one embodiment when the user moves the mobile device in a rotational or angular motion repeatedly back and forth about the X-axis as the center of rotation with respect to the initial stationery position can cause execution of a user interface input command to wind a coiled spring or reel in a virtual fishing game when a user has just caught a fish with an overhead ‘throw’ motion of the mobile device.

As previously explained some defined types of motions are composite motions. For example, a repeated full circular motion can be used to cause execution of an “erase” user interface input command in an application that offers drawing, sketching and/or painting features. In another example, the same full circular motion can also be used to cause execution in a game of a user interface input command to polish, shine, and buff the paint of a car. It is to be understood that in these circular motion examples there is no rotation of the mobile device and therefore there is no axis of rotation. Instead, the device is being translated along a circular path where x=r cos(t) and y=r sin(t) and (x,y) is the current position at time t, r is within a defined range.

In yet another example, a user moving the mobile device “up, right, down and left” (that is, a linear motion up along the y-axis, followed by a linear motion to the right along the x-axis, followed by a linear motion down along the y-axis; followed by a linear motion to the left along the x-axis) can cause execution of a user interface input command to add a border or frame around a displayed image or to crop or re-size a displayed image.

Similarly some composite motions combine a linear motion with an angular motion. For example, a user moving a mobile device in circles (i.e., a rotational or angular motion about the z-axis) while moving the device away from the user (i.e., a linear motion along the z-axis) can cause execution of a user interface input command to tunnel or bore a hole when the mobile device is in the operating context of a treasure hunt game. Another example is a user moving the mobile device in a circular motion (i.e., a rotational or angular lotion about the z-axis) white moving the device down user (i.e., a linear motion along the y-axis) with respect to the initial position to cause execution of a user interface input command of creating turbulence in an AR space (e.g. to simulate a tornado in an AR image when playing a game) when the mobile device is in the operating context of running an AR game.

It is to be understood that the examples given are for illustrative purposes only (for example the diagrams show the mobile device in a landscape orientation, but the methods are applicable in a portrait orientation as well) and may be extended to other implementations and embodiments with a different set of sensors, defined types of motions, conventions and techniques. While a number of embodiments are described, there is no intent to limit the disclosure to the embodiment(s) disclosed herein. On the contrary, the intent is to cover all alternatives, modifications, and equivalents apparent to those familiar with the art.

Likewise, it is to be understood that although the term game has been used as an example the techniques and approach described herein are equally applicable to any other piece of software code, application program, operating system or operating context. There is no intent to limit the disclosure to game applications or player applications and the term player and user are considered synonymous as do games and software applications.

It is to be further understood that the mobile device described herein can be any mobile device with a user interface such as a phone, smartphone (such as the iPhone from Apple, Inc. or phone running the Android OS from Google, Inc. of Mountain View, Calif.), personal digital assistant (PDA), media device such as the iPod or iPod Touch from Apple, Inc.), electronic tablet (such as an iPad from Apple, Inc.), electronic reader device (such as the Kindle from Amazon.com, Inc. of Seattle, Wash.) hand held game console, embedded devices such as electronic toys, etc., that have a processor, memory and display screen.

Further, while a number of the examples are described as a game running on a mobile device, it is to be understood that the game itself, along with the ancillary functions such as sensor operations, device communications, user input and device display generation, etc., can all be implemented in software stored in a computer readable storage medium for access as needed to either run such software on the appropriate processing hardware of the mobile device.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms“comprising,” “including,” and “having,” as used herein, are specifically intended to be read as open-ended terms of art.

What is claimed is:

1. A mobile device user interface method comprising:
detecting motion of the mobile device using one or more sensors located within the mobile device;
confirming by a processor of the mobile device that the detected motion of the mobile device exceeds a preset threshold;
determining by the mobile device processor that the confirmed detected motion of the mobile device matches a defined type of motion; and
executing by the mobile device processor a user interface input command associated with the defined type of motion.

2. The mobile device user interface method of claim 1 wherein the user interface input command associated with the defined type of motion varies depending upon what context in which the mobile device user interface is operating when the step of detecting motion of the mobile device occurs.

3. The mobile device user interface method of claim 1 wherein the one or more sensors comprise at least one sensor from the group comprising a global positioning system, a camera, a compass, a gyroscope and an accelerometer.

4. The mobile device user interface method of claim 1 wherein the defined type of motion is a linear motion.

5. The mobile device user interface method of claim 4 wherein the linear motion is one of the group comprising a linear motion along an x-axis of the mobile device, a linear motion along a y-axis of the mobile device and a linear motion along a z-axis of the mobile device.

6. The mobile device user interface method of claim 4 wherein the linear motion is one of the group comprising a repeated linear motion along an x-axis of the mobile device, a repeated linear motion along a y-axis of the mobile device and a repeated linear motion along a z-axis of the mobile device.

7. The mobile device user interface method of claim 4 wherein the linear motion is one of the group comprising a quick linear motion along an x-axis of the mobile device, a quick linear motion along a y-axis of the mobile device and a quick linear motion along a z-axis of the mobile device.

8. The mobile device user interface method of claim 4 wherein the defined type of motion is an angular motion.

9. The mobile device user interface method of claim 8 wherein the angular motion is one of the group comprising an angular motion about an x-axis of the mobile device, an angular motion about a y-axis of the mobile device and an angular motion about a z-axis of the mobile device.

10. The mobile device user interface method of claim 8 wherein the angular motion is one of the group comprising a repeated angular motion about an x-axis of the mobile device, a repeated angular motion about a y-axis of the mobile device and a repeated angular motion about a z-axis of the mobile device.

11. The mobile device user interface method of claim 1 wherein the defined type of motion is a composite motion comprising more than one linear motion.

12. The mobile device user interface method of claim 11 wherein the composite motion comprising more than one linear motion includes at least one linear motion along an x-axis of the mobile device and at least one linear motion along a y-axis of the mobile device.

13. The mobile device user interface method of claim 1 wherein the defined type of motion is a composite motion comprising both a linear motion and an angular motion.

14. The mobile device user interface method of claim 13 wherein the composite motion comprising both a linear motion and an angular motion includes a linear motion along a z-axis of the mobile device and an angular motion along the z-axis of the mobile device.

15. The mobile device user interface method of claim 1 wherein the user interface input command comprises a first command when the mobile device is in a first operating context and comprises a second command when the mobile device is in a second operating context.

16. A non-transitory computer readable medium containing programming code executable by a processor, the programming code configured to perform a mobile device user interface method, the method comprising:
detecting motion of the mobile device using one or more sensors located within the mobile device;
confirming by a processor of the mobile device that the detected motion of the mobile device exceeds a preset threshold;
determining by the mobile device processor that the confirmed detected motion of the mobile device matches a defined type of motion; and
executing by the mobile device processor a user interface input command associated with the defined type of motion.

17. The non-transitory computer readable medium containing programming code executable by a processor, the programming code configured to perform a mobile device user interface method, the method further comprising:
wherein the user interface input command associated with the defined type of motion varies depending upon what context in which the mobile device user interface is operating when the step of detecting motion of the mobile device occurs.
